(19) United States
(12) Patent Application Publication
(10) Pub. No.: US 2010/0326772 A1
(43) Pub. Date: Dec. 30, 2010

(54) Lubrication Disc Assembly

(76) Inventor: Thomas Peter Corden, Birmingham, MI (US)

Correspondence Address: CLARK HILL, P.C., 500 WOODWARD AVENUE, SUITE 3500, DETROIT, MI, 48226, US

(21) Appl. No.: 12/803,286

(22) Filed: Jun. 23, 2010

Related U.S. Application Data
(60) Provisional application No. 61/269,427, filed on Jun. 24, 2009.

(51) Int. Cl. F16N 9/00

(52) U.S. Cl. 184/102

(57) ABSTRACT

A lubrication disc assembly for lubricating a rod includes a body that circumferentially surrounds the rod and defines a reservoir for storing a lubricant therein. An applicator is disposed within the body directly adjacent the reservoir and contacts the rod. The applicator transfers lubricant from the reservoir to the rod in response to axial movement between the lubrication disc assembly and the rod.

### BACKGROUND OF THE INVENTION

1. Field of the Invention

The present invention relates to a lubrication disc assembly, and more particularly to a lubrication disc assembly having an enclosed reservoir for lubricating a rod.

2. Description of Related Art

Certain fitness equipment, such as weight machines, have rods or shafts for guiding stacks of flat weight plates up and down. Normally, a pair of vertical rods are horizontally spaced apart for guiding the weight plates and each individual weight plate has a pair of spaced apart openings for receiving the rods therethrough. To ensure smooth sliding movement of the weight plates along the rods, lubricant is periodically manually applied along the length of the rods. Manually applying lubricant to the rods is messy and after the weight machine has been used for a period of time the lubricant is wiped off by the reciprocal motion of the weight plates along the rods. If lubricant is not periodically re-applied to the rods the reciprocal motion of the weight plates will damage the rods, which leads to a deterioration of weight machine operation.

Commercial food slicers for slicing meat, cheese, and other food products have rods or shafts for guiding a carriage back and forth. Normally, at least one horizontal rod is mounted to a base of the slicer and the carriage that holds the food to be sliced includes a pair of axially aligned bushings for receiving the rod therethrough. To ensure smooth sliding movement of the carriage along the rod, food grade sanitary lubricant is periodically manually applied along the length of the rod. Manually applying lubricant to the rod is messy and after the slicer has been used for a period of time the lubricant is wiped off by the reciprocal motion of the carriage along the rod. In addition, slicers are commonly steam cleaned at the end of each day to maintain sanitary conditions, however, such steam cleaning accelerates the removal of the lubricant from the rod. Similar to the weight machine above, if lubricant is not periodically re-applied to the rod of the slicer, the reciprocal motion of the carriage will damage the rod, which leads to a deterioration of slicer operation.

It is therefore desirable to provide a lubrication assembly to apply lubricant to an elongated rod whether the rod is extending in a vertical direction, a horizontal direction, or some direction therebetween. Further, it is desirable to provide a lubrication assembly that can be mounted on an elongated rod, wherein the lubrication assembly continuously applies lubricant to the rod at a desired rate.

### SUMMARY OF THE INVENTION

According to one embodiment of the present invention, a lubrication disc assembly lubricates a surface of a rod extending in an axial direction. The lubrication disc assembly includes a body extending in the axial direction between a first end and a second end. The body defines a reservoir for storing a lubricant. The body includes a first axial bore for receiving the rod therethrough. An applicator is disposed within the body directly adjacent the reservoir. The applicator is in fluid communication with the lubricant and directly contacts the rod to transfer the lubricant from the reservoir to the rod in response to axial movement between the lubrication disc assembly and the rod.

According to a second embodiment of the present invention, a lubrication disc assembly lubricates a surface of a rod extending in an axial direction. The lubrication disc assembly includes a body extending in the axial direction between a first end and a second end. The body includes outer and inner walls spaced apart in a radial direction defining a reservoir therebetween for storing a lubricant. The outer wall extends from the first end to the second end and the inner wall extends from a first recessed end to a second recessed end. The first recessed end is spaced apart from the first end in the axial direction and the second recessed end is spaced apart from the second end in the axial direction such that an axial length of the inner wall is less than an axial length of the outer wall. The inner wall defines a first axial bore for receiving the rod therethrough. First and second applicators are disposed within the body directly adjacent opposite ends of the reservoir. Each of the first and second applicators is in fluid communication with the lubricant and directly contacts the rod to transfer the lubricant from the reservoir to the rod in response to axial movement between the lubrication disc assembly and the rod. A first seal is disposed between the first applicator and the first end of the body to prevent the lubricant from leaking through the first end. A second seal is disposed between the second applicator and the second end of the body to prevent the lubricant from leaking through the second end. A first end cap is fixedly secured to the first end of the body to retain the first seal and first applicator within the body. A second end cap is fixedly secured to the second end of the body to retain the second seal and second applicator within the body.

### BRIEF DESCRIPTION OF THE DRAWINGS

Other advantages of the present invention will be readily appreciated as the same becomes better understood by reference to the following detailed description when considered in connection with the accompanying drawings, wherein:

FIG. 1 is a perspective view of a lubrication disc assembly according to a first embodiment of the invention;

FIG. 2 is a cross-sectional view of the lubrication disc assembly in FIG. 1;

FIG. 3 is a cross-sectional view of a lubrication disc assembly according to a second embodiment of the invention; and

FIG. 4 is an enlarged portion of FIG. 3.

### DETAILED DESCRIPTION OF THE EMBODIMENTS

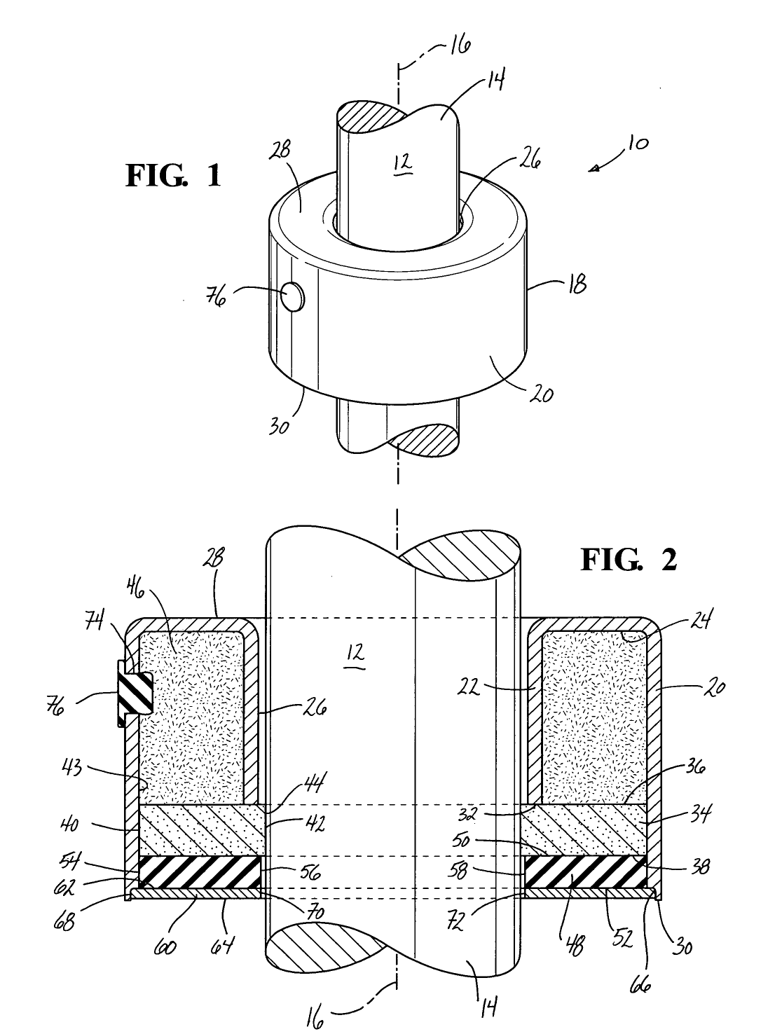

Referring to FIGS. 1 and 2, a lubrication disc assembly, generally shown at 10, is provided for lubricating a surface 12 of an cylindrical rod or shaft 14 that extends along a longitudinal axis 16 in an axial direction. The lubrication disc assembly 10 is slidably coupled to the rod 14 and moves back and forth in the axial direction relative to the rod 14. Alternatively, it is appreciated that the lubrication disc assembly 10 may be mounted to a stationary object while the rod 14 moves back and forth in the axial direction relative to the lubrication disc assembly 10. The lubrication disc assembly 10 is generally donut-shaped and circumferentially surrounds the rod 14. The lubrication disc assembly 10 includes a cylindrical body 18 having an outer wall 20 and an inner wall 22 spaced apart from the outer wall 20 in a radial direction. The radial space between the outer wall 20 and the inner wall 22 defines an internal reservoir 24 therebetween. The inner wall 22 defines a first axial bore 26 for receiving the rod 14 therethrough. The body 18 extends in the axial direction between a first end 28 that is closed and a second end 30 that is open. The outer wall 20 extends between the first end 28 and the second end 30. The inner wall 22 extends between the first end 28 and a recessed end 32 that is spaced apart in the axial direction from the second end 30. More specifically, the recessed end 32 of the inner wall 22 is offset towards the first end 28 such that the axial length of the inner wall 22 is less than the axial length of the outer wall 20. The internal reservoir 24 extends in the axial direction between the first end 28 of the body 18 and a plane defined by the recessed end 32 of the inner wall 22 that is perpendicular to the longitudinal axis 16.

An applicator 34, typically made from felt or some other suitable material, is provided to transfer lubricant from the internal reservoir 24 to the surface 12 of the rod 14. The applicator 34 is generally donut-shaped and circumferentially surrounds the rod 14. The applicator 34 includes opposing first and second sides 36, 38 spaced apart in the axial direction, thereby defining a thickness of the applicator 34. The applicator 34 is disposed directly adjacent to the plane defined by the recessed end 32 of the inner wall 22 such that the first side 36 of the applicator 34 acts as a boundary for the internal reservoir 24. The applicator 34 includes an outer circumference 40 and an inner circumference 42 spaced apart from the outer circumference 40 in the radial direction. The outer circumference 40 is sized such that the applicator 34 is in direct contact with an inner surface 43 of the outer wall 20 around the entire circumference of the cylindrical body 18. The inner circumference 42 defines a second axial bore 44 that is coaxial with the first axial bore 26 of the body 18 for receiving the rod 14 therethrough. The inner circumference 42 is sized such that the applicator 34 is in direct contact with the surface 12 of the rod 14 around the entire circumference of the rod 14. Thus, the inner circumference 42 of the applicator 34 will wipe the surface 12 of the rod 14 with lubricant as the lubrication disc assembly 10 moves back and forth in the axial direction relative to the rod 14 or the rod 14 moves back and forth in the axial direction relative to the lubrication disc assembly 10, as the case may be.

The internal reservoir 24 of the cylindrical body 18 is filled with a lubricant storing and releasing material 46, such as an oil impregnated, fibrous wicking material as is disclosed in commonly owned U.S. Pat. Nos. 3,466,244; 3,214,375; and 2,966,459, which are hereby incorporated by reference. The lubricant storing and releasing material 46 is contained within the internal reservoir 24 and releases a lubricant to the applicator 34, which in turn applies the lubricant to the surface 12 of the rod 14 as the lubrication disc assembly 10 moves back and forth in the axial direction relative to the rod 14 or the rod 14 moves back and forth in the axial direction relative to the lubrication disc assembly 10. One example of the lubricant storing and releasing material 46 contained within the internal reservoir 24 is sold under the trademark PERMAWICK®, which is produced by Permawick Company of Bingham Farms, Mich. The rate at which the lubricant is released from the lubricant storing and releasing material 46 and the composition of the applicator 34 controls the amount of lubricant that is transferred from the internal reservoir 24 onto the surface 12 of the rod 14.

A washer or seal 48, typically made from rubber or some other suitable material, is provided to prevent lubricant from seeping through the second side 38 of the applicator 34 toward the second or open end 30 of the body 18. The seal 48 is generally donut-shaped and circumferentially surrounds the rod 14. The seal 48 includes opposing first and second sides 50, 52 spaced apart in the axial direction, thereby defining a thickness of the seal 48. The seal 48 is disposed directly adjacent to the applicator 34 such that the first side 50 of the seal 48 is in direct contact with the second side 38 of the applicator 34. The seal 48 helps ensure the lubricant from the lubricant storing and releasing material 46 is directed through the applicator 34 and onto the surface 12 of the rod 14. The seal 48 includes an outer circumference 54 and an inner circumference 56 spaced apart from the outer circumference 54 in the radial direction. The outer circumference 54 of the seal 48 is sized such that the seal 48 is in direct contact with the inner surface 43 of the outer wall 20 around the entire circumference of the body 18. The inner circumference 56 defines a third axial bore 58 for receiving the rod 14 therethrough. The third axial bore 58 is coaxial with the second axial bore 44 of the applicator 34 and the first axial bore 26 of the body 18. Preferably, the inner circumference 56 of the seal 48 does not contact the surface 12 of the rod 14 such that there is a space therebetween. The space between the inner circumference 56 of the seal 48 and the surface 12 of the rod 14 is minimized to prevent debris, including moisture, from getting into the internal reservoir 24. Contact between the inner circumference 56 of the seal 48 and the surface 12 of the rod 14 is detrimental to the operation of the lubrication disc assembly 10 because such contact will place an undesirable drag on the reciprocal motion between the lubrication disc assembly 10 and the rod 14.

An end cap 60 is provided to close the second or open end 30 of the body 18 and to securely retain the seal 48 and applicator 34 in place. The end cap 60 is generally donut-shaped and circumferentially surrounds the rod 14. The end cap 60 includes opposing first and second sides 62, 64 spaced apart in the axial direction, thereby defining a thickness of the end cap 60. The end cap 60 is disposed directly adjacent to the seal 48 such that the first side 62 of the end cap 60 is in direct contact with the second side 52 of the seal 48. In the embodiment shown, a small step or lip 66 is formed in the outer wall 20 at the second end 30 of the body 18. The lip 66 extends circumferentially around the body 18 and is adapted to receive the end cap 60 as is described below. The end cap 60 includes an outer circumference 68 and an inner circumference 70 spaced apart from the outer circumference 68 in the radial direction. The outer circumference 68 of the end cap 60 is press-fit into the lip 66 in the outer wall 20 such that the end cap 60 is fixedly secured to the body 18 and retains the seal 48 and applicator 34 in place. The second side 64 of the end cap 60 is generally flush with the end of the outer wall 18 at the second end 30 of the body 18. The inner circumference 70 defines a fourth axial bore 72 for receiving the rod 14 therethrough. The fourth axial bore 72 is coaxial with the third axial bore 58 of the seal 48, the second axial bore 44 of the applicator 34, and the first axial bore 26 of the body 18. It is contemplated that the seal 48 can be incorporated as part of the end cap 60 without varying from the scope of the invention.

The lubrication disc assembly 10 may also include a reservoir fill hole 74 extending through the outer wall 20 of the cylindrical body 18. The reservoir fill hole 74 is provided to allow for periodically adding lubricant to the lubricant storing and releasing material 46 contained within the internal reservoir 24. A cap or plug 76 is inserted into the reservoir fill hole 74 to seal the reservoir fill hole 74 to retain the lubricant storing and releasing material 46 within the internal reservoir 24.

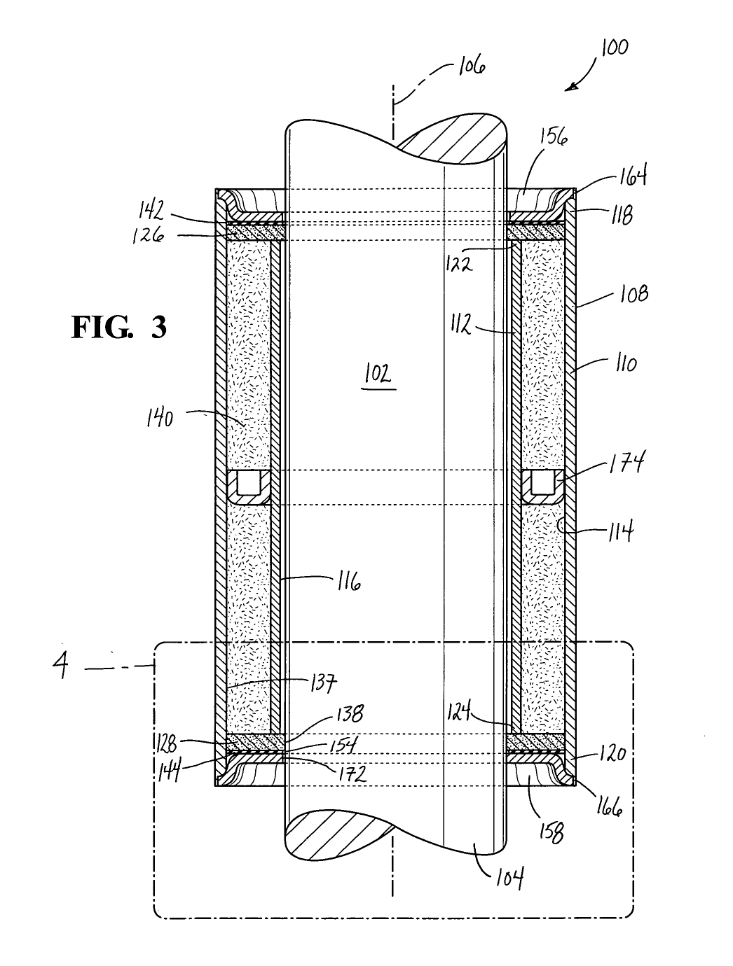

A second embodiment of a lubrication disc assembly is generally shown at 100 in FIG. 3. The second embodiment of the lubrication disc assembly 100 is substantially similar to the first embodiment except the second embodiment includes a pair of applicators, a pair of seals, and a pair of end caps, as is described below in more detail.

The lubrication disc assembly 100 is provided for lubricating a surface 102 of a cylindrical rod 104 that extends along a longitudinal axis 106 in an axial direction. The lubrication disc assembly 100 is slidably coupled to the rod 104 and moves back and forth in the axial direction relative to the rod 104. Alternatively, it is appreciated that the lubrication disc assembly 100 may be mounted to a stationary object while the rod 104 moves back and forth in the axial direction relative to the lubrication disc assembly 100. The lubrication disc assembly 100 is generally donut-shaped and circumferentially surrounds the rod 104. The lubrication disc assembly 100 includes a cylindrical body 108 having an outer wall 110 and an inner wall 112 spaced apart from the outer wall 110 in a radial direction. The radial space between the outer wall 110 and the inner wall 112 defines an internal reservoir 114 therebetween. The inner wall 112 defines a first axial bore 116 for receiving the rod 104 therethrough. The body 108 extends in the axial direction between a first end 118 and a second end 120, both of which are open, in contrast with the first embodiment. The outer wall 110 extends between the first end 118 and the second end 120. The inner wall 112 extends between a first recessed end 122 that is spaced apart in the axial direction from the first end 118 and a second recessed end 124 that is spaced apart in the axial direction from the second end 120. More specifically, the first recessed end 122 is offset towards the second end 120 and the second recessed end 124 is offset towards the first end 118 such that the axial length of the inner wall 112 is less than the axial length of the outer wall 110. The internal reservoir 114 extends in the axial direction between a first plane defined by the first recessed end 122 of the inner wall 112 that is perpendicular to the longitudinal axis 106 and a second plane defined by the second recessed end 124 of the inner wall 112 that is perpendicular to the longitudinal axis 106.

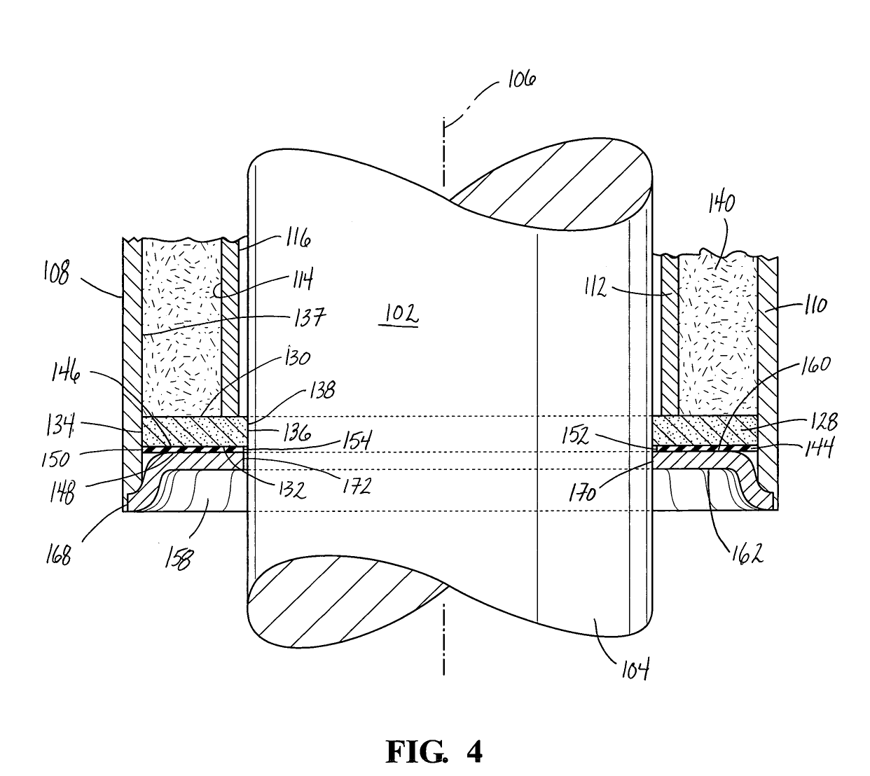

Referring to FIGS. 3 and 4, first and second applicators 126, 128, typically made from felt or some other suitable material, are provided to transfer lubricant from the internal reservoir 114 to the surface 102 of the rod 104. Each of the first and second applicators 126, 128 is generally donut-shaped and circumferentially surrounds the rod 104. Each of the first and second applicators 126, 128 includes opposing first and second sides 130, 132 spaced apart in the axial direction, thereby defining a thickness of the first and second applicators 126, 128. The first applicator 126 is disposed directly adjacent to the plane defined by the first recessed end 122 of the inner wall 112 such that the first side 130 acts as a first boundary for the internal reservoir 114. Similarly, the second applicator 128 is disposed directly adjacent to the plane defined by the second recessed end 124 of the inner wall 112 such that the first side 130 acts as a second boundary for the internal reservoir 114. Each of the first and second applicators 126, 128 includes an outer circumference 134 and an inner circumference 136 spaced apart from the outer circumference 134 in the radial direction. The outer circumference 134 is sized such that the first and second applicators 126, 128 are in direct contact with an inner surface 137 of the outer wall 110 around the entire circumference of the body 108. The inner circumference 136 defines a second axial bore 138 that is coaxial with the first axial bore 116 of the body 108 for receiving the rod 104 therethrough. The inner circumference 136 is sized such that the first and second applicators 126, 128 are in direct contact with the surface 102 of the rod 104 around the entire circumference of the rod 104. Thus, the inner circumference 136 of the first and second applicators 126, 128 will wipe the surface 102 of the rod 104 with lubricant as the lubrication disc assembly 100 moves back and forth in the axial direction relative to the rod 104 or the rod 104 moves back and forth in the axial direction relative to the lubrication disc assembly 100, as the case may be.

The internal reservoir 114 of the body 108 is filled with a lubricant storing and releasing material 140, as disclosed with respect to the first embodiment. The lubricant storing and releasing material 140 is contained within the internal reservoir 114 and releases a lubricant to the first and second applicators 126, 128, which in turn apply the lubricant to the surface 102 of the rod 104 as the lubrication disc assembly 100 moves back and forth in the axial direction relative to the rod 104 or the rod 104 moves back and forth in the axial direction relative to the lubrication disc assembly 100. The rate at which the lubricant is released from the lubricant storing and releasing material 140 and the composition of the first and second applicators 126, 128 control the amount of lubricant that is transferred from the internal reservoir 114 onto the surface 102 of the rod 104.

First and second seals 142, 144, typically made from rubber or some other suitable material, are provided to prevent lubricant from seeping through the second side 132 of the first and second applicators 126, 128 toward the first and second ends 118, 120 of the body 108. Each of the first and second seals 142, 144 are generally donut-shaped and circumferentially surrounds the rod 104. Each of the first and second seals 142, 144 includes opposing first and second sides 146, 148 spaced apart in the axial direction, thereby defining a thickness of the first and second seals 142, 144. The first seal 142 is disposed directly adjacent to the first applicator 126 such that the first side 146 of the first seal 142 is in direct contact with the second side 132 of the first applicator 126. Similarly, the second seal 144 is disposed directly adjacent to the second applicator 128 such that the first side 146 of the second seal 144 is in direct contact with the second side 132 of the second applicator 128. Each of the first and second seals 142, 144 help ensure the lubricant from the lubricant storing and releasing material 140 is directed through the first and second applicators 126, 128 and onto the surface 102 of the rod 104. Each of the first and second seals 142, 144 includes an outer circumference 150 and an inner circumference 152 spaced apart from the outer circumference 150 in the radial direction. The outer circumference 150 is sized such that the first and second seals 142, 144 are in direct contact with the inner surface 137 of the outer wall 110 around the entire circumference of the body 108. The inner circumference 152 defines a third axial bore 154 for receiving the rod 104 therethrough. The third axial bore 154 is coaxial with the second axial bore 138 of the first and second applicators 126, 128 and the first axial bore 116 of the body 108. Preferably, the inner circumference 152 of the first and second seals 142, 144 does not contact the surface 102 of the rod 104 such that there is a space therebetween. The space between the inner circumference 152 of the first and second seals 142, 144 and the surface 102 of the rod 104 is minimized to prevent debris, including moisture, from getting into the internal reservoir 114. Contact between the inner circumference 152 of the first and second seals 142, 144 and the surface 102 of the rod 104 is detrimental to the operation of the lubrication disc assembly 100 because such contact will place an undesirable drag on the reciprocal motion between the lubrication disc assembly 100 and the rod 104.

First and second end caps 156, 158 are provided to close each end of the body 108 and to securely retain the first and second seals 142, 144 and first and second applicators 126, 128 in place. Each of the first and second end caps 156, 158 is generally donut-shaped and circumferentially surrounds the rod 104. Each of the first and second end caps 156, 158 includes opposing first and second sides 160, 162 spaced apart in the axial direction, thereby defining a thickness of the first and second end caps 156, 158. The first end cap 156 is disposed directly adjacent to the first seal 142 such that the first side 160 of the first end cap 156 is in direct contact with the second side 148 of the first seal 142. Similarly, the second end cap 158 is disposed directly adjacent to the second seal 144 such that the first side 160 of the second end cap 158 is in direct contact with the second side 148 of the second seal 144. In the embodiment shown, a first lip 164 is formed in the outer wall 110 at the first end 118 of the body 108 and a second lip 166 is formed in the outer wall 110 at the second end 120 of the body 108. Each of the first and second lips 164, 166 extend circumferentially around the body 108 and is adapted to receive one of the first and second end caps 156, 158, as is described below. Each of the first and second end caps 156, 158 include an outer circumference 168 and an inner circumference 170 spaced apart from the outer circumference 168 in the radial direction. The outer circumference 168 of the first end cap 156 is press-fit into the first lip 164 in the outer wall 110 such that the first end cap 156 is fixedly secured to the body 108 and retains the first seal 142 and first applicator 126 in place. The second side 162 of the first end cap 156 is generally flush with the end of the outer wall 110 at the first end 118 of the body 108. Similarly, the outer circumference 168 of the second end cap 158 is press-fit into the second lip 166 in the outer wall 110 such that the second end cap 158 is fixedly secured to the body 108 and retains the second seal 144 and second applicator 128 in place. The second side 162 of the second end cap 158 is generally flush with the end of the outer wall 110 at the second end 120 of the body 108. The inner circumference 170 of each of the first and second end caps 156, 158 defines a fourth axial bore 172 for receiving the rod 104 therethrough. The fourth axial bore 172 is coaxial with the third axial bore 154 of the first and second seals 142, 144, the second axial bore 138 of the first and second applicators 126, 128, and the first axial bore 116 of the cylindrical body 108.

The lubrication disc assembly 100 disclosed in the second embodiment also includes a spacer 174 disposed between the outer wall 110 and the inner wall 112 of the body 108 to provide added structural support thereto. The spacer 174 is positioned axially generally midway between the first and second ends 118, 120 of the body 108.

In each of the first and second embodiments shown, the body 18, 108 of the lubrication disc assembly 10, 100 is generally cylindrical, however, it is appreciated that the body 18, 108 can be any suitable shape depending on size constraints or aesthetic considerations without varying from the scope of the invention. Also, it is disclosed that the first axial bore 26, 116, the second axial bore 44, 138, the third axial bore 58, 154, and the fourth axial bore 72, 172 each have a generally circular cross-section for receiving the cylindrical rod 14, 104 therethrough. It is appreciated that the cross-section of each of the first axial bore 26, 116, the second axial bore 44, 138, the third axial bore 58, 154, and the fourth axial bore 72, 172 is generally complimentary to the cross-section of the rod 14, 104. Thus, the rod 14, 104, the first axial bore 26, 116, the second axial bore 44, 138, the third axial bore 58, 154, and the fourth axial bore 72, 172 may have any cross-section that allows the lubrication disc assembly 10, 100 and the rod 14, 104 to move back and forth in the axial direction relative to one another.

There are many contemplated applications for the first and second embodiments of the lubrication disc assembly 10, 100, two of which are set forth herein. In a first application, the lubrication disc assembly 10, 100 can be disposed along a vertically extending rod of a weight machine. More specifically, a pair of lubrication disc assemblies 10, 100 are coupled to a weight plate that is guided along a pair of rods. During normal operation of the weight machine the lubrication disc assemblies 10, 100 continuously lubricate the rods as the weight plate travels up and down along the rods.

In a second application, the lubrication disc assembly 10, 100 can be disposed along a horizontally extending rod of a food slicer. More specifically, the lubrication disc assembly 10, 100 is coupled to a carriage that is guided along the rod. During normal operation of the food slicer the lubrication disc assembly 10, 100 continuously lubricates the rod as the carriage travels back and forth along the rod.

The invention has been described here in an illustrative manner, and it is to be understood that the terminology used is intended to be in the nature of words of description rather than limitation. Many modifications and variations of the present invention are possible in light of the above teachings. It is, therefore, to be understood that within the scope of the appended claims, the invention may be practiced other than as specifically enumerated within the description.

What is claimed:

1. A lubrication disc assembly for lubricating a surface of a rod extending in an axial direction, said lubrication disc assembly comprising:
a lubricant;
a body extending in the axial direction between a first end and a second end, said body defining a reservoir for storing said lubricant therein, wherein said body includes a first axial bore adapted for receiving the rod therethrough; and
an applicator disposed within said body directly adjacent said reservoir, said applicator is in fluid communication with said lubricant and is adapted for directly contacting the rod thereby transferring said lubricant from said reservoir to the rod in response to axial movement between said lubrication disc assembly and the rod.

2. The lubrication disc assembly as set forth in claim 1 including a seal disposed within said body between said applicator and said second end of said body, said seal preventing said lubricant from leaking through said second end.

3. The lubrication disc assembly as set forth in claim 2 including an end cap fixedly secured to said second end of said body, said end cap retaining said seal and said applicator within said body.

4. The lubrication disc assembly as set forth in claim 3 wherein each of said body, said applicator, said seal, and said end cap is adapted for circumferentially surrounding the rod.

5. The lubrication disc assembly as set forth in claim 3 wherein said body includes an outer wall and an inner wall spaced apart from said outer wall in a radial direction, said outer and inner walls defining said reservoir therebetween.

6. The lubrication disc assembly as set forth in claim 5 wherein said applicator includes a first outer circumference and a first inner circumference spaced apart from said first outer circumference in a radial direction, said first outer circumference directly contacting an inner surface of said outer wall, and said first inner circumference defining a second axial bore adapted for receiving the rod therethrough.

7. The lubrication disc assembly as set forth in claim 6 wherein said seal includes a second outer circumference and a second inner circumference spaced apart from said second outer circumference in said radial direction, said second outer circumference directly contacting said inner surface of said outer wall, and said second inner circumference defining a third axial bore adapted for receiving the rod therethrough.

8. The lubrication disc assembly as set forth in claim 7 wherein said end cap includes a third outer circumference and a third inner circumference spaced apart from said third outer circumference in said radial direction, said third outer circumference directly contacting said outer wall, and said third inner circumference defining a fourth axial bore adapted for receiving the rod therethrough.

9. The lubrication disc assembly as set forth in claim 8 wherein said outer wall extends from said first end to said second end and said inner wall extends from said first end to a recessed end, said recessed end spaced apart from said second end in the axial direction such that an axial length of said inner wall is less than an axial length of said outer wall.

10. The lubrication disc assembly as set forth in claim 9 wherein said outer wall includes a recessed lip extending circumferentially around said second end of said body, said recessed lip receiving said third outer circumference of said end cap therein.

11. The lubrication disc assembly as set forth in claim 10 wherein said body includes a re-sealable hole extending through said outer wall allowing access to said reservoir for periodically adding said lubricant.

12. A lubrication disc assembly for lubricating a surface of a rod extending in an axial direction, said lubrication disc assembly comprising:
a lubricant;
a body extending in the axial direction between a first closed end and a second open end, said body including an outer wall and an inner wall spaced apart from said outer wall in a radial direction defining a reservoir between said outer and inner walls for storing said lubricant therein, wherein said outer wall extends from said first closed end to said second open end and said inner wall extends from said first closed end to a recessed end, said recessed end spaced apart from said second open end such that an axial length of said inner wall is less than an axial length of said outer wall, and wherein said inner wall defines a first axial bore adapted for receiving the rod therethrough;
an applicator disposed within said body directly adjacent said recessed end of said inner wall and said reservoir, said applicator in fluid communication with said lubricant and adapted for directly contacting the rod thereby transferring said lubricant from said reservoir to the rod in response to axial movement between said lubrication disc assembly and the rod; and
an end cap fixedly secured to said second open end of said body retaining said applicator within said body.

13. The lubrication disc assembly as set forth in claim 12 including a seal disposed within said body between said applicator and said end cap, said seal preventing said lubricant from leaking through said second open end of said body.

14. The lubrication disc assembly as set forth in claim 13 wherein said applicator includes a first outer circumference and a first inner circumference spaced apart from said first outer circumference in a radial direction, said first outer circumference directly contacting an inner surface of said outer wall, and said first inner circumference defining a second axial bore adapted for receiving the rod therethrough.

15. The lubrication disc assembly as set forth in claim 14 wherein said seal includes a second outer circumference and a second inner circumference spaced apart from said second outer circumference in said radial direction, said second outer circumference directly contacting said inner surface of said outer wall, and said second inner circumference defining a third axial bore adapted for receiving the rod therethrough.

16. The lubrication disc assembly as set forth in claim 15 wherein said end cap includes a third outer circumference and a third inner circumference spaced apart from said third outer circumference in said radial direction, said third outer circumference directly contacting said outer wall, and said third inner circumference defining a fourth axial bore adapted for receiving the rod therethrough.

17. A lubrication disc assembly for lubricating a surface of a rod extending in an axial direction, said lubrication disc assembly comprising:
a lubricant;
a body extending in the axial direction between a first end and a second end, said body including an outer wall and an inner wall spaced apart from said outer wall in a radial direction defining a reservoir between said outer and inner walls for storing said lubricant therein, wherein said outer wall extends from said first end to said second end and said inner wall extends from a first recessed end to a second recessed end, said first recessed end spaced apart from said first end in the axial direction and said second recessed end spaced apart from the second end in the axial direction such that an axial length of said inner wall is less than an axial length of said outer wall, and wherein said inner wall defines a first axial bore adapted for receiving the rod therethrough;
first and second applicators disposed within said body directly adjacent opposite ends of said reservoir, each of said first and second applicators is in fluid communication with said lubricant and is adapted for directly contacting the rod thereby transferring said lubricant from said reservoir to the rod in response to axial movement between said lubrication disc assembly and the rod;
first and second seals disposed within said body, said first seal disposed between said first applicator and said first end of said body to prevent said lubricant from leaking through said first end, and said second seal disposed between said second applicator and said second end of said body to prevent said lubricant from leaking through said second end; and
first and second end caps, said first end cap fixedly secured to said first end of said body retaining said first seal and said first applicator within said body, and said second end cap fixedly secured to said second end of said body retaining said second seal and said second applicator within said body.

18. The lubrication disc assembly as set forth in claim 17 wherein each of said first and second applicators includes a first outer circumference and a first inner circumference spaced apart from said first outer circumference in a radial direction, said first outer circumference directly contacting an inner surface of said outer wall, and said first inner circumference defining a second axial bore adapted for receiving the rod therethrough.

19. The lubrication disc assembly as set forth in claim 18 wherein each of said first and second seals includes a second outer circumference and a second inner circumference spaced apart from said second outer circumference in said radial direction, said second outer circumference directly contacting said inner surface of said outer wall, and said second inner circumference defining a third axial bore adapted for receiving the rod therethrough.

20. The lubrication disc assembly as set forth in claim 19 wherein each of said first and second end caps includes a third outer circumference and a third inner circumference spaced apart from said third outer circumference in said radial direction, said third outer circumference directly contacting said outer wall, and said third inner circumference defining a fourth axial bore adapted for receiving the rod therethrough.

21. The lubrication disc assembly as set forth in claim 20 wherein said outer wall includes a first recessed lip extending circumferentially around said first end of said body and a second recessed lip extending circumferentially around said second end of said body, said first recessed lip receiving said third outer circumference of said first end cap therein, and said second recessed lip receiving said third outer circumference of said second cap therein.
